(19) United States
(12) Patent Application Publication
(10) Pub. No.: US 2026/0322478 A1
(43) Pub. Date: Oct. 15, 2026

(54) JOINT OPTIMIZATION OF LOCATION, BEAM, AND RADIO RESOURCE FOR AN AERIAL BASE STATION WITH CONTROLLABLE DIRECTIONAL ANTENNAS

(71) Applicants: UIF (University Industry Foundation), Yonsei University, Seoul (KR); INCHEON NATIONAL UNIVERSITY RESEARCH & BUSINESS FOUNDATION, Incheon (KR)

(72) Inventors: Jang-Won LEE, Seoul (KR); Jonghyeon WON, Seoul (KR); Do-Yup KIM, Incheon (KR)

(73) Assignees: UIF (University Industry Foundation), Yonsei University, Seoul (KR); INCHEON NATIONAL UNIVERSITY RESEARCH & BUSINESS FOUNDATION, Incheon (KR)

(21) Appl. No.: 19/435,386

(22) Filed: Dec. 29, 2025

Related U.S. Application Data
(63) Continuation of application No. PCT/KR2024/011321, filed on Aug. 1, 2024.

(30) Foreign Application Priority Data
Aug. 30, 2023 (KR) 10-2023-0114803
May 22, 2024 (KR) 10-2024-0066682

(51) Int. Cl. H04B 7/185

(52) U.S. Cl. CPC H04B 7/18504; H04B 7/18506; H04B 7/18513

(57) ABSTRACT

A technology for operating a UAV-enabled network is disclosed. In one embodiment, a method for determining a flight path, beam parameters, and resource allocation of an aerial base station by an electronic device in a system including a ground base station, an aerial base station, and a plurality of user equipment receiving data from the ground base station through relay by the aerial base station includes: setting requirement conditions including a minimum required data rate condition for each user equipment; and determining the flight path, beam parameters, and resource allocation of the aerial base station to maximize a sum of received data rates of the plurality of user equipment while satisfying the set requirement conditions.

### CROSS-REFERENCE TO RELATED APPLICATIONS

This application is a bypass continuation under 35 U.S.C. § 111 (a) of International Patent Application No. PCT/KR2024/011321, filed on Aug. 1, 2024, which claims priority to Korean Patent Application No. 10-2024-0066682, filed on May 22, 2024 and Korean Patent Application No. 10-2023-0114803, filed on Aug. 30, 2023, the disclosures of which are incorporated herein by reference in their entirety.

### TECHNICAL FIELD

The present disclosure relates to technology for operating unmanned aerial vehicle (UAV)-enabled networks, and more particularly, to technology for optimizing flight path, beam parameters, and resource allocation of an aerial base station.

### BACKGROUND

Unmanned aerial vehicles (UAVs) have many advantages including flexible deployment in three-dimensional space, fast mobility, compact size, and low cost, and thus are widely used in various fields. Wireless networks are one such field where UAVs can be utilized to enhance network performance. Based on this potential, research on integrating UAVs into wireless networks has been actively conducted, referred to as UAV-enabled networks. For example, a UAV can serve as an aerial base station (ABS) to relay data between a ground base station (GBS) and ground users (GUs).

Generally, there are two types of communication antennas: omnidirectional antennas and directional antennas. A directional antenna can adjust its beam direction and beamwidth, thereby controlling the antenna gain. Therefore, when a directional antenna is mounted on a UAV, it may be necessary to optimally control its beam direction and beamwidth.

Since the optimal beam direction and beamwidth may vary depending on the location of the UAV, joint optimization of location, beam direction, and beamwidth may be required in UAV-enabled networks with directional antennas. Additionally, joint optimization of location, beam direction, beamwidth, and resource allocation may be necessary for efficient resource utilization in UAV-enabled networks.

For example, there may be a need for technology that optimizes a UAV's location, beam direction, beamwidth, and resource allocation while satisfying predetermined conditions (e.g., quality of service (QoS) conditions).

### SUMMARY

An aspect of the present disclosure provides technology for efficiently operating a UAV-enabled network (e.g., technology for optimizing a UAV's location, beam direction, beam parameters, and resource allocation while satisfying predetermined conditions).

According to an aspect of the present disclosure, there is provided a method for determining a flight path, beam parameters, and resource allocation of an aerial base station by an electronic device in a system including a ground base station, an aerial base station, and a plurality of user equipment receiving data from the ground base station through relay by the aerial base station, the method comprising: setting requirement conditions including a minimum required data rate condition for each user equipment; and determining the flight path, beam parameters, and resource allocation of the aerial base station to maximize a sum of received data rates of the plurality of user equipment while satisfying the set requirement conditions.

In some embodiments, the resources subject to resource allocation may include at least one of: transmit power allocated when the aerial base station transmits data to the plurality of user equipment; bandwidth allocated when the aerial base station transmits data to the plurality of user equipment; and a ratio of resources used by a link between the ground base station and the aerial base station (hereinafter, backhaul link) and links between the aerial base station and the plurality of user equipment (hereinafter, access links).

In some embodiments, the system may operate based on a plurality of time slots, and each of the plurality of time slots may include a time sub-slot for the backhaul link and a time sub-slot for the access links. In some embodiments, the ground base station may transmit data to the aerial base station using the time sub-slot for the backhaul link included in each of the plurality of time slots, and the aerial base station may transmit data to the plurality of user equipment using the time sub-slot for the access links included in each of the plurality of time slots. In some embodiments, the ratio of resources may be a ratio of the time sub-slot for the access links to the time slot.

In some embodiments, the beam parameters may include at least one of a transmit beam direction and a transmit beamwidth of the aerial base station.

In some embodiments, the flight path may include locations of the aerial base station during the relay, and the requirement conditions may further include a minimum height and a maximum height that the locations can have.

In some embodiments, the requirement conditions may further include a minimum beamwidth supported by the aerial base station.

In some embodiments, the determining step may be performed based on solving an optimization problem expressed by the following mathematical expression:

$${maximize}_{{x}_{ABS} , φ , Ω , b , p , δ} {{\sum }_{i = 1}}^{N} {\overline{R}}_{i} ( {x}_{ABS} , φ , Ω , b , p , δ )$$

$$subject to {\overline{R}}_{i} ( {x}_{A B S} , φ , Ω , b , p , δ ) \geq {R}_{min , i} ∀ i = 1 , 2 , … , N ,$$

$${\sum }_{i = 1}^{N} {\overline{R}}_{i} ( {x}_{ABS} , φ , Ω , b , p , δ ) \leq {\overline{R}}_{0} ( {x}_{ABS} , δ ) ,$$

$${\sum }_{i = 1}^{N} {b}_{i} \leq {B}_{max} ,$$

$${\sum }_{i = 1}^{N} {p}_{i} \leq {P}_{max} ,$$

$${H}_{min} \leq {h}_{A B S} \leq {H}_{max} ,$$

$$0 \leq θ \leq 2 π , 0 \leq ϕ \leq \frac{π}{2} ,$$

$${Ω}_{min} \leq Ω \leq \frac{π}{2} ,$$

$${b}_{i} , {p}_{i} \geq 0 , ∀ i = 1 , 2 , … , N ,$$

$$0 \leq δ \leq 1$$

where R̅ᵢ(x_{ABS}, φ, Ω, b, p, δ) and R_{min,i} represent the received data rate and minimum required data rate of the i-th user equipment, respectively; R̅₀(x_{ABS}, δ) represents the data rate of the backhaul link; x_{ABS}, φ, and Ω represent the location, transmit beam direction, and transmit beamwidth of the aerial base station, respectively; bᵢ and pᵢ represent the bandwidth and transmit power allocated for transmission to the i-th user equipment, respectively; φ represents the beam direction expressed in azimuth angle θ and elevation angle φ; Ω and Ωₘᵢₙ represent the beamwidth and minimum beamwidth of the aerial base station, respectively; Bₘₐₓ represents the maximum bandwidth of the system; Pₘₐₓ represents the maximum transmit power of the aerial base station; h_{ABS}, Hₘᵢₙ, and Hₘₐₓ represent the height of the aerial base station location, and the minimum and maximum heights at which the aerial base station can be located during the relay service period, respectively; N represents the number of the plurality of user equipment; and δ represents the ratio of the time sub-slot for the access links in a time slot composed of a backhaul link sub-slot and an access link sub-slot.

In some embodiments, the resources subject to resource allocation may include: transmit power allocated when the aerial base station transmits data to the plurality of user equipment; bandwidth allocated when the aerial base station transmits data to the plurality of user equipment; and a ratio of resources used by the backhaul link and the access links, and the determining step may include: determining the flight path, power allocation, and bandwidth allocation of the aerial base station to maximize the sum of received data rates of the plurality of user equipment while satisfying the set requirement conditions; and determining beam parameters and the ratio of resources based on the determined flight path, power allocation, and bandwidth allocation of the aerial base station.

In some embodiments, the step of determining the beam parameters and the ratio of resources may include: determining the beam parameters based on the determined flight path of the aerial base station; and determining the ratio of resources based on the determined flight path, power allocation, bandwidth allocation, and beam parameters of the aerial base station.

In some embodiments, the beam parameters may include the transmit beam direction and transmit beamwidth of the aerial base station, and the determining step may include: determining the flight path of the aerial base station; and determining the beam direction and beamwidth based on the determined flight path.

In some embodiments, the step of determining the beam direction and beamwidth may include determining the beam direction and beamwidth such that the transmit beam of the aerial base station simultaneously covers all of the plurality of user equipment and the circle formed by the transmit beam is as small as possible.

In some embodiments, the determining step may include: obtaining an optimal objective value of the optimization problem for a given flight path in the optimization problem for determining the flight path, beam parameters, and resource allocation of the aerial base station to maximize the sum of received data rates of the plurality of user equipment while satisfying the set requirement conditions; determining the flight path of the aerial base station based on the obtained optimal objective value; and determining the beam parameters and resource allocation of the aerial base station based on the determined flight path.

In some embodiments, the step of obtaining the optimal objective value and the step of determining the flight path may be performed based on a particle swarm optimization (PSO) algorithm.

In some embodiments, the step of determining the beam parameters and resource allocation of the aerial base station may include: determining the beam parameters based on the determined flight path of the aerial base station; and determining the resource allocation based on the determined beam parameters.

In some embodiments, the resources subject to resource allocation may include: transmit power allocated when the aerial base station transmits data to the plurality of user equipment; bandwidth allocated when the aerial base station transmits data to the plurality of user equipment; and a ratio of resources used by the backhaul link and the access links, and the step of determining the resource allocation may include: determining transmit power allocation and bandwidth allocation; and determining the ratio of resources based on the determined flight path, beam parameters, transmit power allocation, and bandwidth allocation.

In some embodiments, the electronic device may be the aerial base station, and the method may further include performing relay based on the determined flight path, beam parameters, and resource allocation.

In some embodiments, the electronic device may be a device physically separated from the aerial base station, and the method may further include providing information about the determined flight path, beam parameters, and resource allocation to the aerial base station.

According to another aspect of the present disclosure, there is provided an electronic device for determining a flight path, beam parameters, and resource allocation of an aerial base station in a system including a ground base station, an aerial base station, and a plurality of user equipment receiving data from the ground base station through relay by the aerial base station, the electronic device comprising: a processor; and a computer-readable storage medium containing instructions that, when executed by the processor, cause the electronic device to perform the method according to any one of the above embodiments.

According to yet another aspect of the present disclosure, there is provided a non-transitory recording medium storing instructions readable by a processor of an electronic device, wherein the instructions cause the processor to perform the method according to any one of the above embodiments.

Some exemplary embodiments of the present disclosure may have an effect including the following advantages. However, since it is not meant that all exemplary embodiments should include all of them, the scope of the present disclosure should not be understood as being limited thereto.

According to some embodiments, a UAV-enabled network with excellent system performance (e.g., sum of received data rates of user equipment) can be provided while satisfying requirement conditions (e.g., minimum required data rate conditions).

According to some embodiments, the location, beam direction, beamwidth, and resource allocation of the ABS can be jointly optimized in a UAV-enabled network using a directional antenna.

This overview is provided to introduce in a simplified form the selected concepts among those that are further explained in the detailed description below. The present disclosure is not intended to identify a core feature or essential feature of the subject matter of the claimed disclosure and is not intended to be used to limit the scope of the subject matter of the claimed disclosure. Also, the subject matter of the claimed disclosure is not limited to implementations that solve some or all of the problems mentioned in any part of the present specification. In addition to the above exemplary aspects, exemplary embodiments and features, additional aspects, embodiments, and features will become apparent with reference to the detailed description and drawings below.

### BRIEF DESCRIPTION OF THE DRAWINGS

FIG. 1 illustrates a system for explaining some embodiments of a UAV-enabled network.

FIG. 2 illustrates a time slot that the system may use.

FIG. 3 is a conceptual diagram for explaining a smallest circle problem.

FIG. 4 illustrates an algorithm for determining optimal beam direction and optimal beamwidth based on the smallest circle problem.

FIG. 5 illustrates an algorithm for obtaining the optimal solution and optimal objective value of the optimization problem of Equation 11.

FIG. 6 illustrates an algorithm for obtaining an optimal solution by applying the PSO algorithm.

FIG. 7 is a block diagram illustrating an electronic device that performs a method according to embodiments of the present disclosure.

### DETAILED DESCRIPTION

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

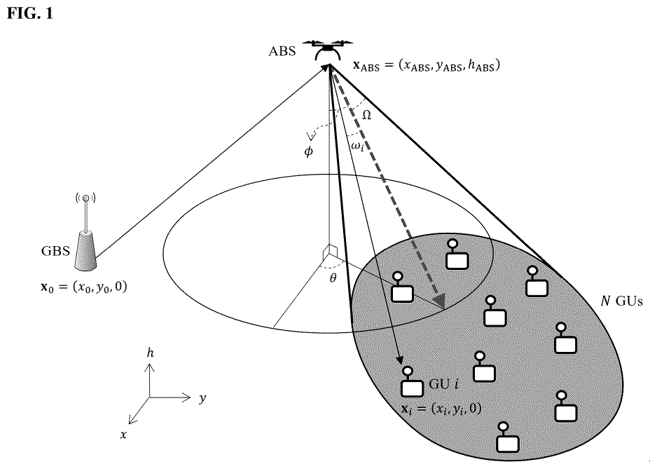

FIG. 1 illustrates a system for explaining some embodiments of a UAV-enabled network.

In some embodiments, as illustrated in FIG. 1, a system 100 may include a GBS 110, an ABS 120, and user equipment (UE) 130_1, 130_2, . . . , 130_9 of GUs.

In some embodiments, the ABS 120 may be implemented as a UAV.

In some embodiments, each GU (user index i=1, . . . , N, where N=9 in FIG. 1) may receive communication services through communication between its UE 130_1, 130_2, . . . , 130_9 and the ABS 120. For example, the ABS 120 may receive data transmitted from the GBS 110 (downlink data) through a backhaul link and then transmit the received data to the corresponding UE through an access link. As another example, the ABS 120 may receive data transmitted from each UE (uplink data) through the access link and then transmit the received data to the GBS 110 through the backhaul link. Hereinafter, for convenience, some embodiments will be described assuming the former case (relaying downlink data).

In some embodiments, the ABS 120 may fly according to a path for relay service (i.e., flight path) and may adjust its beam direction (φ) and beamwidth (Ω).

For example, the flight path may be represented as a set of locations (x_{ABS}=(x_{ABS}, y_{ABS}, h_{ABS})) at which the ABS 120 flies during the relay service.

For example, the beam direction (φ) may be represented by an azimuth angle (θ) and an elevation angle (φ), as illustrated in FIG. 1.

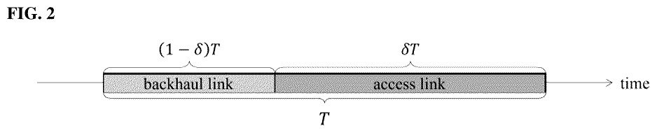

FIG. 2 illustrates a time slot that the system may use.

In some embodiments, as illustrated in FIG. 2, communication devices within the system 100 may perform communication in units of time slots (T). For example, each time slot (T) may be partitioned according to the time ratio δ between the access link and the backhaul link, and may be composed of a sub-slot for the access link and a sub-slot for the backhaul link.

In some embodiments, for access link transmission (in the case of downlink transmission, from the ABS to each UE), power (p₁, p₂, p₃, . . . , p_{N}) and bandwidth (b₁, b₂, b₃, . . . , b_{N}) may be allocated.

In some embodiments, in the UAV-enabled network system illustrated in FIG. 1, an electronic device may determine the flight path, beam parameters, and resource allocation of the ABS (e.g., the ABS illustrated in FIG. 1), and the UAV may perform relay services based on the determined results.

Hereinafter, for convenience, the electronic device that determines the flight path, beam parameters, and resource allocation will be referred to as an optimization device to explain some embodiments. For example, the optimization device may be the ABS. In this case, the ABS may determine the flight path, beam parameters, and resource allocation, and the UAV may perform relay services based on the determined results. As another example, the optimization device may be a device physically separated from the ABS (e.g., the GBS illustrated in FIG. 1, or a separate device not shown in FIG. 1). In this case, the optimization device may provide information about the determined flight path, beam parameters, and resource allocation to the ABS, so that the ABS performs relay services accordingly.

In some embodiments, the optimization device may set requirement conditions, and then determine the flight path, beam parameters, and resource allocation of the ABS to maximize the sum of received data rates of a plurality of user equipment (e.g., UEs of the GUs illustrated in FIG. 1) while satisfying the set requirement conditions.

In some embodiments, the requirement conditions may include minimum required data rate conditions for each user equipment.

In some embodiments, the resources subject to resource allocation may include at least one of: transmit power allocated when the ABS transmits data to the plurality of user equipment; bandwidth allocated when the ABS transmits data to the plurality of user equipment; and a ratio of resources used by the backhaul link and the access links.

In some embodiments, the ratio of resources may be the ratio (δ) of the time sub-slot for the access links to the time slot.

In some embodiments, the beam parameters may include at least one of the transmit beam direction (φ) and transmit beamwidth (Ω) of the ABS.

In some embodiments, the flight path may include locations (x_{ABS}) of the ABS during the relay, and the requirement conditions may further include minimum height (Hₘᵢₙ) and maximum height (Hₘₐₓ) that the locations can have.

In some embodiments, the requirement conditions may further include a minimum beamwidth (Ωₘᵢₙ) supported by the aerial base station.

In some embodiments, the optimization device may determine the flight path, beam parameters, and resource allocation of the ABS by obtaining a solution to the optimization problem represented by Equation 1.

$$[ Equation 1 ]$$

$${maximize}_{{x}_{ABS} , φ , Ω , b , p , δ} {{\sum }_{i = 1}}^{N} {\overline{R}}_{i} ( {x}_{ABS} , φ , Ω , b , p , δ ) \qquad ( 1 a )$$

$$subject to {\overline{R}}_{i} ( {x}_{A B S} , φ , Ω , b , p , δ ) \geq {R}_{min , i} ∀ i = 1 , 2 , … , N , \qquad ( 1 b )$$

$${\sum }_{i = 1}^{N} {\overline{R}}_{i} ( {x}_{ABS} , φ , Ω , b , p , δ ) \leq {\overline{R}}_{0} ( {x}_{ABS} , δ ) , \qquad ( 1 c )$$

$${\sum }_{i = 1}^{N} {b}_{i} \leq {B}_{max} , \qquad ( 1 d )$$

$${\sum }_{i = 1}^{N} {p}_{i} \leq {P}_{max} , \qquad ( 1 e )$$

$${H}_{min} \leq {h}_{A B S} \leq {H}_{max} , \qquad ( 1 f )$$

$$0 \leq θ \leq 2 π , 0 \leq ϕ \leq \frac{π}{2} , \qquad ( 1 g )$$

$${Ω}_{min} \leq Ω \leq \frac{π}{2} , \qquad ( 1 h )$$

$${b}_{i} , {p}_{i} \geq 0 , ∀ i = 1 , 2 , … , N , \qquad ( 1 i )$$

$$0 \leq δ \leq 1 \qquad ( 1 j )$$

Here, i represents an index of user equipment (UEs of GUs in FIG. 1) and may have values from 1 to N (9 in the case of FIG. 1).

R̅ᵢ(x_{ABS}, φ, Ω, b, p, δ)) and R_{min,i} represent the received data rate and minimum required data rate of the i-th user equipment, respectively. R̅₀(x_{ABS}, δ) represents the data rate of the backhaul link. R̅₀(x_{ABS}, δ) and R̅ᵢ(x_{ABS}, φ, Ω, b, p, δ) may be represented by Equations 2 and 3.

bᵢ and pᵢ represent the bandwidth and transmit power allocated for transmission to the i-th user equipment, respectively. Bₘₐₓ represents the maximum bandwidth of the system, and Pₘₐₓ represents the maximum transmit power of the ABS. h_{ABS} represents the height among the location of the ABS.

In Equation 1, constraint (1b) is the aforementioned data rate requirement condition, and constraints (1c) to (1j) are conditions that the system must fundamentally satisfy for the relay service or represent minimum or maximum values of each parameter.

R̅₀(x_{ABS},δ)=(1−δ)R₀(x_{ABS}) [Equation 2]

R̅ᵢ(x_{ABS},φ,Ω,b,p,δ)=δRᵢ(x_{ABS},φ,Ω,b,p) [Equation 3]

In Equations 2 and 3, R₀(x_{ABS}) and Rᵢ(x_{ABS}, φ, Ω, b, p) represent the achievable data rate of the backhaul link and the achievable data rate of the i-th UE-related link among the access links, respectively, and may be represented by Equations 4 and 5.

$$[ Equation 4 ]$$

$${R}_{0} ( {x}_{A B S} ) = {b}_{0} {log}_{2} ( 1 + \frac{{g}_{0} ( {x}_{A B S} ) {p}_{0}}{{b}_{0} {N}_{0}} )$$

$$[ Equation 5 ]$$

$${R}_{i} ( {x}_{ABS ,} φ , Ω , b , p ) = {b}_{i} {log}_{2} ( 1 + \frac{{g}_{i} ( {x}_{ABS} , φ , Ω ) {p}_{i}}{{b}_{i} {N}_{0}} )$$

In Equation 4, p₀ and b₀ are the transmit power and bandwidth of the GBS 110, respectively, and in some embodiments, may be set to fixed values (e.g., b₀=Bₘₐₓ) in the optimization problem. g₀(x_{ABS}) is the channel gain of the backhaul link and may be expressed as a function of the distance between the GBS 110 and the ABS 120, various constants (path loss constants, etc.), the transmit antenna gain of the GBS 110, and the receive antenna gain of the ABS 120. The transmit antenna gain of the GBS 110 and the receive antenna gain of the ABS 120 may be set to fixed values in the optimization problem. N₀ is the noise spectral density.

In Equation 5, pᵢ and bᵢ are the transmit power and bandwidth of the ABS 110 for the link to the i-th UE. gᵢ(x_{ABS}, φ, Ω) is the channel gain of the corresponding link and may be expressed as a function of the distance between the ABS 110 and the corresponding UE, various constants (path loss constants, etc.), the transmit antenna gain of the ABS 110, and the receive antenna gain of the corresponding UE. In some embodiments, the transmit antenna gain of the ABS 110 may be expressed as a function of the transmit beamwidth of the ABS 120. In some embodiments, the receive antenna gain of the corresponding UE may be set to a fixed value in the optimization problem.

Consequently, R̅ᵢ(x_{ABS}, φ, Ω, b, p, δ) and R̅₀(x_{ABS}, δ) may be expressed by the decision variables of the optimization problem of Equation 1.

In some embodiments, the optimization device may determine the flight path, power allocation, and bandwidth allocation of the aerial base station to maximize the sum of received data rates of the plurality of user equipment while satisfying the set requirement conditions, and may determine the beam parameters and the ratio of resources based on the determined flight path, power allocation, and bandwidth allocation of the aerial base station. For example, this is because Equation 1 can be reconstructed as an optimization problem with only x_{ABS}, b, and p as decision variables.

In some embodiments, the optimization device may determine the beam parameters based on the determined flight path of the aerial base station, and may determine the ratio (δ) of resources based on the determined flight path, power allocation, bandwidth allocation, and beam parameters of the aerial base station.

For example, the optimization device may obtain the ratio (δ) of resources using Equation 6.

$$[ Equation 6 ]$$

$$δ = \frac{{R}_{0} ( {x}_{A B S} )}{{R}_{0} ( {x}_{A B S} ) + {\sum }_{i = 1}^{N} {R}_{i} ( {x}_{ABS} , φ , Ω , {b}_{i} , {p}_{i} )}$$

For example, by applying Equation 6 to Equation 1, Equation 7 without the decision variable δ is obtained.

$$[ Equation 7 ]$$

$${maximize}_{{x}_{ABS} , φ , Ω , b , p} \frac{{R}_{0} ( {x}_{A B S} ) {\sum }_{i = 1}^{N} {R}_{i} ( {x}_{ABS} , φ , Ω , {b}_{i} , {p}_{i} )}{{R}_{0} ( {x}_{A B S} ) + {\sum }_{i = 1}^{N} {R}_{i} ( {x}_{A B S} , φ , {b}_{i} , {p}_{i} )} \qquad ( 7 a )$$

$$subject to \frac{{R}_{0} ( {x}_{A B S} ) {\sum }_{i = 1}^{N} {R}_{i} ( {x}_{ABS} , φ , Ω , {b}_{i} , {p}_{i} )}{{R}_{0} ( {x}_{A B S} ) + {\sum }_{i = 1}^{N} {R}_{i} ( {x}_{A B S} , φ , {b}_{i} , {p}_{i} )} \geq {R}_{min , i} ∀ i = 1 , 2 , … , N , \qquad ( 7 b )$$

$$( 1 d ) , ( 1 e ) , ( 1 f ) , ( 1 g ) , ( 1 h ) , ( 1 i ) .$$

In some embodiments, the optimization device may determine the flight path of the ABS and may determine the beam direction and beamwidth based on the determined flight path.

The optimization device may determine the optimal beam direction and optimal beamwidth by solving a smallest circle enclosing problem based on the determined flight path. As a method for solving the smallest circle problem, a technique presented in the paper E. Welzl, “Smallest enclosing disks (balls and ellipsoids),” in New Results and New Trends in Computer Science, 1991, pp. 359-370 may be used.

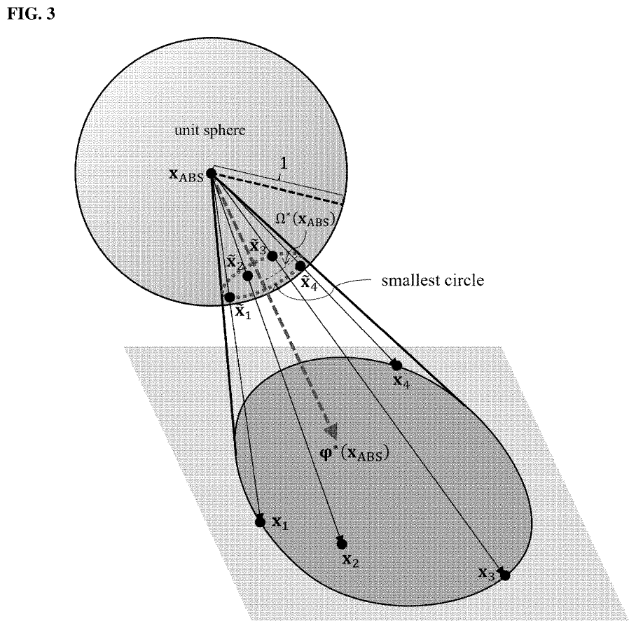

FIG. 3 is a conceptual diagram for explaining the smallest circle problem.

In some embodiments, the optimization device may determine the beam direction and beamwidth such that the transmit beam of the ABS simultaneously covers all of the plurality of user equipment and the circle formed by the transmit beam (the dotted circle shown in FIG. 3) is as small as possible. That is, the optimization device may use the smallest circle problem, which is a problem of finding the smallest circle containing a finite set of points in a plane, to obtain φ*(x_{ABS}) and Ω*(x_{ABS}) for a given x_{ABS}, as illustrated in FIG. 3.

For example, the optimization device may determine the optimal beam direction and optimal beamwidth using Equations 8 and 9.

$$[ Equation 8 ]$$

$$φ ⋆ ( {x}_{A B S} ) = {arg min}_{φ} \{ {max}_{i ∈ \{ 1 , 2 , … , N \}} {‖ {\tilde{x}}_{i} - φ ‖}_{s} \}$$

$$[ Equation 9 ]$$

$$Ω ⋆ ( {x}_{ABS} ) = {min}_{φ} \{ {max}_{i ∈ \{ 1 , 2 , … , N \}} {‖ {\tilde{x}}_{i} - φ ‖}_{s} \}$$

Here, the distance ∥·∥s is computed in the spherical coordinate system.

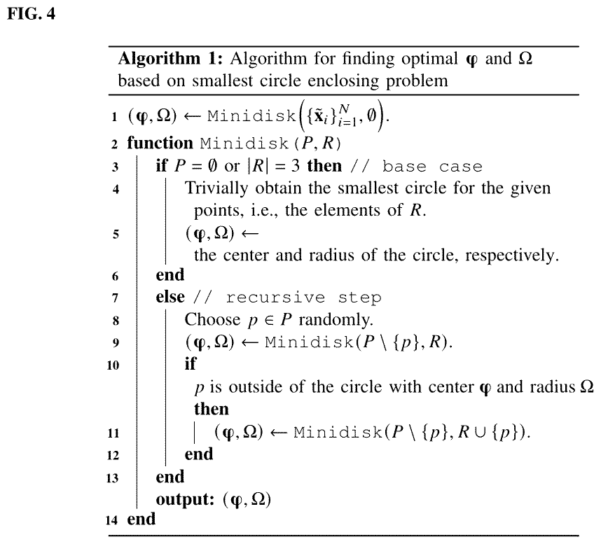

FIG. 4 illustrates an algorithm for determining optimal beam direction and optimal beamwidth based on the smallest circle problem.

For example, the optimization device may determine the optimal beam direction and optimal beamwidth using Algorithm 1 illustrated in FIG. 4.

Algorithm 1, as illustrated in FIG. 4, follows the structure of a recursive algorithm.

As base cases, the smallest circle can be easily obtained when the number of given points is three or fewer (lines 3-6 of Algorithm 1).

For the recursive step, one of the given points is randomly selected, and the smallest circle of the remaining points excluding the selected point is obtained (lines 8-9 of Algorithm 1).

If the selected point is outside the smallest circle obtained above, the recursive step is performed by finding the smallest circle such that the point lies on it (i.e., on the circle's line) (lines 10-13 of Algorithm 1).

By performing the algorithm recursively in this manner, a circle in which all given points are inside or on it may finally be provided (line 14 of Algorithm 1).

The resulting circle is the smallest circle for the given N points, \tilde{x}₁, \tilde{x}₂, . . . , \tilde{x}_{N}.

In some embodiments, the obtained φ*(x_{ABS}) and Ω*(x_{ABS}) may be finally determined as the optimal beam direction and beamwidth after adjustment if the range condition is not satisfied. For example, if the obtained beamwidth Ω*(x_{ABS}) is smaller than the minimum beamwidth Ωₘᵢₙ, Ω* (x_{ABS}) may be finally determined as Ωₘᵢₙ.

By replacing φ and Ω in the optimization problem of Equation 7 with φ*(x_{ABS}) of Equation 8 and Ω*(x_{ABS}) of Equation 9, respectively, the optimization problem of Equation 7 may be reconstructed as Equation 10 for a given x_{ABS}.

$$[ Equation 10 ]$$

$${maximize}_{b , p} {\sum }_{i = 1}^{N} \frac{{R}_{0} ( {x}_{A B S} ) {\tilde{R}}_{i} ( {x}_{ABS} , {b}_{i} , {p}_{i} )}{{R}_{0} ( {x}_{A B S} ) + {\sum }_{i = 1}^{N} {\tilde{R}}_{i} ( {x}_{A B S} , {b}_{i} , {p}_{i} )} , \qquad ( 10 a )$$

$$subject to \frac{{R}_{0} ( {x}_{A B S} ) {\tilde{R}}_{i} ( {x}_{ABS} , {b}_{i} , {p}_{i} )}{{R}_{0} ( {x}_{A B S} ) + {\sum }_{i = 1}^{N} {\tilde{R}}_{i} ( {x}_{A B S} , {b}_{i} , {p}_{i} )} \geq {R}_{min , i} ∀ i = 1 , 2 , … , N , \qquad ( 10 b )$$

$$( 1 d ) , ( 1 e ) , ( 1 i ) . \qquad ( 10 c )$$

Here, \tilde{R}ᵢ(x_{ABS}, bᵢ, pᵢ) is used instead of R̅ᵢ(x_{ABS}, φ*(x_{ABS}), Ω*(x_{ABS}), bᵢ, pᵢ) for simplicity of explanation.

The objective function (10a) of Equation 10 is a concave function, and constraints (1d), (1e), and (1i) are all linear inequalities that satisfy the condition for a convex set. Therefore, the optimization problem of Equation 10 is a convex optimization problem. The optimization problem of Equation 10 may be solved using standard algorithms for convex optimization problems. Hereinafter, the solution of the optimization problem of Equation 10 will be denoted as b*(x_{ABS}) and p*(x_{ABS}).

As described above, for a given x_{ABS}, the optimal solution (φ, Ω, b, p, and δ) of the optimization problem of Equation 1 may be obtained. That is, the optimization problem of Equation 1 for a given x_{ABS} may be expressed as the optimization problem of Equation 11.

$$[ Equation 1 ]$$

$${maximize}_{φ , Ω , b , p , δ} {{\sum }_{i = 1}}^{N} {\overline{R}}_{i} ( {x}_{ABS} , φ , Ω , b , p , δ ) \qquad ( 11 a )$$

$$subject to ( 1 b ) , ( 1 c ) , ( 1 d ) , ( 1 e ) , ( 1 g ) , ( 1 h ) , ( 1 i ) , ( 1 j ) , \qquad ( 11 b )$$

Hereinafter, the optimal objective value of problem (11) for a given x_{ABS} will be denoted as S(x_{ABS}), and its optimal solutions will be denoted as φ*(x_{ABS}), (Ω*(x_{ABS}), b*(x_{ABS}), p*(x_{ABS}), and δ*(x_{ABS}).

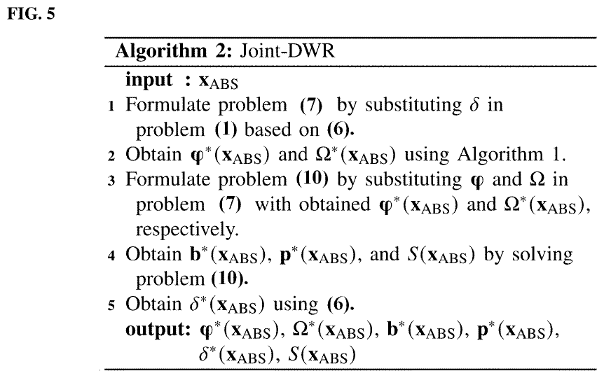

FIG. 5 illustrates an algorithm for obtaining the optimal solution and optimal objective value of the problem of Equation 11.

The optimization device substitutes 8 expressed in Equation 6 into Equation 1 to derive Equation 7 (line 1 of Algorithm 2).

The optimization device obtains φ*(x_{ABS}) and (Ω*(x_{ABS}) using Algorithm 1 (e.g., Algorithm 1 illustrated in FIG. 4) (line 2 of Algorithm 2).

The optimization device substitutes the obtained φ*(x_{ABS}) and Ω*(x_{ABS}) into Equation 7 to formulate the optimization problem of Equation 10 (line 3 of Algorithm 2).

The optimization device solves the optimization problem of Equation 10 to obtain b*(x_{ABS}), p*(x_{ABS}), and S(x_{ABS}) (line 4 of Algorithm 2).

The optimization device obtains δ*(x_{ABS}) using Equation 6.

The only remaining task to solve the problem of Equation 1 is to obtain the optimal solution for x_{ABS}. To this end, the following optimization problem must be solved.

$$[ Equation 12 ]$$

$${maximize}_{{x}_{ABS}} S ( {x}_{ABS} ) \qquad ( 12 a )$$

$$subject to ( 1 f ) . \qquad ( 12 b )$$

In some embodiments, the optimization device may apply a particle swarm optimization (PSO) algorithm to obtain a solution to the problem of Equation 12. This is because S(x_{ABS}) is difficult to express in a closed-form expression of x_{ABS}, making it difficult to analytically solve the problem of Equation 12. Detailed descriptions of the PSO algorithm itself are found in the papers J. Kennedy and R. Eberhart, “Particle swarm optimization,” in Proc. Int. Conf. Neural Netw. (ICNN'95), 1995, pp. 1942-1948, and R. Poli, J. Kennedy, and T. Blackwell, “Particle swarm optimization,” Swarm Intell., vol. 1, no. 1, pp. 33-57, August 2007.

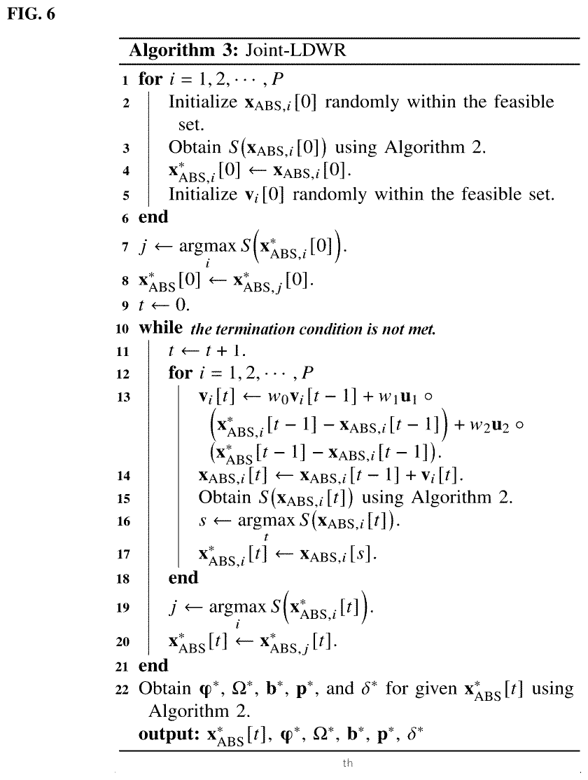

FIG. 6 illustrates an algorithm for obtaining an optimal solution by applying the PSO algorithm.

In Algorithm 3, x_{ABS,i}[t] represents the position of the i-th particle at the t-th iteration, and vᵢ[t] represents the updated difference in the position of the i-th particle.

$${x}_{A B S , i}^{*} [ t ]$$

is the best position of the i-th particle until the t-th iteration, and

$${x}_{A B S}^{*} [ t ]$$

is the best position among all particles until the t-th iteration.

In some embodiments, the optimization device may obtain the optimal objective value of the optimization problem for a given flight path, determine the flight path of the aerial base station based on the obtained optimal objective value (up to line 21 of Algorithm 3), and then determine the beam parameters and resource allocation of the aerial base station based on the determined flight path (line 22 of Algorithm 3).

In some embodiments, the optimization device may obtain the optimal objective value and determine the flight path based on the particle swarm optimization (PSO) algorithm.

In some embodiments, the optimization device may determine the beam parameters based on the determined flight path of the aerial base station, and may determine the resource allocation based on the determined beam parameters.

In some embodiments, in determining the resource allocation, the optimization device may determine transmit power allocation and bandwidth allocation, and may determine the ratio of resources based on the determined flight path, beam parameters, transmit power allocation, and bandwidth allocation.

Referring to FIG. 6, through lines 1-6, the initial position of each particle is set, and S(x_{ABS,i}[0]) is obtained using Algorithm 2 based on the set initial position x_{ABS,i}[0]. The best position

$${x}_{A B S , i}^{*} [ 0 ]$$

is updated to the set initial position x_{ABS,i}[0], and vᵢ[0] is randomly initialized within the feasible set.

Through lines 7-8, the largest value among the P (x_{ABS,i}[0]) values obtained previously is set as

$${x}_{ABS , i}^{*} [ 0 ] .$$

Then, lines 11-20 are repeated by increasing the iteration index t until the given termination condition is satisfied. Termination conditions may include the maximum value of the iteration index, the overall execution time of the algorithm, the number of iteration indices in which the optimal solution is not updated, and the execution time in which the optimal solution is not updated.

vᵢ[t] is updated by the equation in line 13, and the updated vᵢ[t] is used to determine the next position of each particle in line 14.

After convergence,

$${x}_{A B S}^{*} [ t ]$$

is selected as the optimal position value, and it is used to obtain the optimal solutions φ*(x_{ABS}), Ω*(x_{ABS}), b*(x_{ABS}), p*(x_{ABS}), and δ*(x_{ABS}) using Algorithm 2 in line 22.

Through Algorithm 3, an approximate optimal solution of the problem of Equation 12 may be obtained, which means that the original problem, the problem of Equation 1, may be approximately solved.

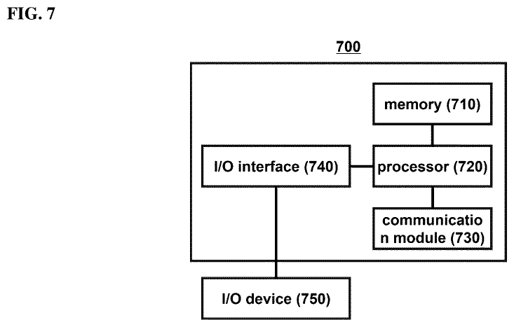

FIG. 7 is a block diagram illustrating an electronic device that performs a method according to embodiments of the present disclosure. In FIG. 7, the electronic device 700 is described as a single physical device, but depending on embodiments, the electronic device 700 may also be implemented in a form in which a plurality of devices are linked (e.g., distributed computing).

In some embodiments, as illustrated in FIG. 7, the electronic device 700 may include a memory 710, a processor 720, and a communication module 730. In other embodiments, it may further include all or part of an input/output interface 740 and other units. For example, if the electronic device 700 performing the embodiments is an unmanned aerial vehicle, it may further include a unit such as a flight means.

The memory 710 may include a non-volatile mass storage device such as random access memory (RAM), read only memory (ROM), and a disk drive as a recording medium readable by an electronic device (e.g., computer). Here, the ROM and the non-volatile mass storage device may also be included as a separate permanent storage device separated from the memory 710. Also, an operating system and at least one program code (e.g., a program such as a computer program stored on a recording medium included in the electronic device 700 to control the electronic device 700 to perform the method according to embodiments of the present disclosure) may be stored in the memory 710. These software components may be loaded from a recording medium readable by an electronic device separate from the memory 710. Such a recording medium readable by a separate electronic device may include a recording medium readable by an electronic device such as a floppy drive, a disk, a tape, a DVD/CD-ROM drive, and a memory card. In another embodiment, software components may also be loaded into the memory 710 through the communication module 730 rather than a recording medium readable by an electronic device.

The processor 720 may be configured to process instructions of a program such as a computer program by performing basic arithmetic, logic, and input/output operations. The instructions may be provided to the processor 720 by the memory 710 or the communication module 730. For example, the processor 720 may be configured to execute received instructions according to program code loaded in the memory 710. More specifically, the processor 720 may sequentially execute instructions according to the code of a computer program loaded in the memory 710 to perform UAV-enabled network-related processing (e.g., optimization of flight path, beam parameters, and resource allocation of an aerial base station) according to embodiments of the present disclosure. The communication module 730 may provide a function for communicating with other physical devices through a communication network such as a computer network. For example, the processor 720 of the electronic device 700 performs part of the processes of the present embodiment, and another physical device of the communication network (e.g., another electronic device such as another computer, not shown) performs the remaining processes, and the processing results may be exchanged through the communication network and the communication module 730 to perform the embodiments of the present disclosure.

The input/output interface 740 may be a means for interfacing with an input/output device 750. For example, in the input/output device 750, input devices may include devices such as a keyboard or mouse, and output devices may include devices such as a display or speaker. In FIG. 7, the input/output device 750 is shown as a separate device from the electronic device 700, but depending on embodiments, the electronic device 700 may also be implemented to include the input/output device 750.

The above-described apparatus may be implemented as hardware components, software components, and/or a combination of hardware components and software components. For example, the apparatus and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The electronic device 700 may execute an operating system (OS) and one or more software applications running on the operating system. Also, the electronic device 700 may access, store, manipulate, process, and generate data in response to execution of software. For ease of understanding, there may be cases where the electronic device 700 is described as one being used, but those of ordinary skill in the art may understand that the electronic device 700 may include a plurality of processing elements and/or a plurality of types of processing elements. For example, the electronic device 700 may include a plurality of processors or one processor and one controller. Also, other processing configurations, such as a parallel processor, are possible.

Software may include computer programs, code, instructions, or a combination of one or more thereof, and may configure the electronic device 700 to operate as desired or may independently or collectively instruct the electronic device 700. Software and/or data may be embodied in any type of machine, component, physical device, computer storage medium, or device to be interpreted by the electronic device 700 or to provide instructions or data to the electronic device 700. Software may be distributed over networked computer systems and stored or executed in a distributed manner. Software and data may be stored on one or more computer-readable recording media.

The method according to the embodiments may be implemented in the form of program instructions that can be executed through various computer means and recorded on a computer-readable medium. In this case, the medium may continuously store a computer-executable program, or temporarily store it for execution or download. Also, the medium may be various recording means or storage means in a form in which single or several pieces of hardware are combined, and is not limited to a medium directly connected to any computer system, and may be distributed on a network. Examples of the medium include magnetic media such as hard disks, floppy disks, and magnetic tapes, optical recording media such as CD-ROM and DVD, magneto-optical media such as floptical disks, and those configured to store program instructions including ROM, RAM, flash memory, and the like. Also, other examples of the medium may include recording media or storage media managed by app stores that distribute applications, sites that supply or distribute various software, and servers.

Although the embodiments have been described with reference to limited embodiments and drawings as set forth above, a person having ordinary knowledge in the technical field would be able to make various modifications and variations from the above description. For example, the described techniques may be performed in a different order than the described method, and/or components of the described system, structure, device, circuit, etc. may be combined or joined in a form different from the described method, or even if replaced or substituted by other components or equivalents, appropriate results can still be achieved.

Therefore, other implementations, other embodiments, and things equivalent to the claims also fall within the scope of the claims set forth hereinafter.

What is claimed is:

1. A method for determining a flight path, beam parameters, and resource allocation of an aerial base station by an electronic device in a system including a ground base station, an aerial base station, and a plurality of user equipment receiving data from the ground base station through relay by the aerial base station, the method comprising:
setting requirement conditions including a minimum required data rate condition for each user equipment; and
determining the flight path, beam parameters, and resource allocation of the aerial base station to maximize a sum of received data rates of the plurality of user equipment while satisfying the set requirement conditions.

2. The method of claim 1, wherein the resources subject to resource allocation include at least one of:
transmit power allocated when the aerial base station transmits data to the plurality of user equipment;
bandwidth allocated when the aerial base station transmits data to the plurality of user equipment; and
a ratio of resources used by a link between the ground base station and the aerial base station (backhaul link) and links between the aerial base station and the plurality of user equipment (access links).

3. The method of claim 2, wherein:
the system operates based on a plurality of time slots,
each of the plurality of time slots includes a time sub-slot for the backhaul link and a time sub-slot for the access links,
the ground base station transmits data to the aerial base station using the time sub-slot for the backhaul link included in each of the plurality of time slots,
the aerial base station transmits data to the plurality of user equipment using the time sub-slot for the access links included in each of the plurality of time slots, and
the ratio of resources is a ratio of the time sub-slot for the access links to the time slot.

4. The method of claim 1, wherein the beam parameters include at least one of a transmit beam direction and a transmit beamwidth of the aerial base station.

5. The method of claim 1, wherein:
the flight path includes locations of the aerial base station during the relay, and
the requirement conditions further include a minimum height and a maximum height that the locations can have.

6. The method of claim 1, wherein the requirement conditions further include a minimum beamwidth supported by the aerial base station.

7. The method of claim 1, wherein the determining step is performed based on solving an optimization problem expressed by the following mathematical expression:
$${maximize}_{{x}_{ABS} , φ , Ω , b , p , δ} {{\sum }_{i = 1}}^{N} {\overline{R}}_{i} ( {x}_{ABS} , φ , Ω , b , p , δ )$$
$$subject to {\overline{R}}_{i} ( {x}_{A B S} , φ , Ω , b , p , δ ) \geq {R}_{min , i} ∀ i = 1 , 2 , … , N ,$$
$${\sum }_{i = 1}^{N} {\overline{R}}_{i} ( {x}_{ABS} , φ , Ω , b , p , δ ) \leq {\overline{R}}_{0} ( {x}_{ABS} , δ ) ,$$
$${\sum }_{i = 1}^{N} {b}_{i} \leq {B}_{max} ,$$
$${\sum }_{i = 1}^{N} {p}_{i} \leq {P}_{max} ,$$
$${H}_{min} \leq {h}_{A B S} \leq {H}_{max} ,$$
$$0 \leq θ \leq 2 π , 0 \leq ϕ \leq \frac{π}{2} ,$$
$${Ω}_{min} \leq Ω \leq \frac{π}{2} ,$$
$${b}_{i} , {p}_{i} \geq 0 , ∀ i = 1 , 2 , … , N ,$$
$$0 \leq δ \leq 1$$
where R̅ᵢ(x_{ABS}, φ, Ω, b, p, δ) and R_{min,i} represent the received data rate and minimum required data rate of the i-th user equipment, respectively; R̅₀(x_{ABS}, δ) represents the data rate of the backhaul link; x_{ABS}, φ, and Ω represent the location, transmit beam direction, and transmit beamwidth of the aerial base station, respectively; bᵢ and pᵢ represent the bandwidth and transmit power allocated for transmission to the i-th user equipment, respectively; φ represents the beam direction expressed in azimuth angle θ and elevation angle φ; Ω and Ωₘᵢₙ represent the beamwidth and minimum beamwidth of the aerial base station, respectively; Bₘₐₓ represents the maximum bandwidth of the system; Pₘₐₓ represents the maximum transmit power of the aerial base station; h_{ABS}, Hₘᵢₙ, and Hₘₐₓ represent the height of the aerial base station location, and the minimum and maximum heights at which the aerial base station can be located during the relay service period, respectively; N represents the number of the plurality of user equipment; and δ represents the ratio of the time sub-slot for the access links in a time slot composed of a backhaul link sub-slot and an access link sub-slot.

8. The method of claim 1, wherein the resources subject to resource allocation include transmit power allocated when the aerial base station transmits data to the plurality of user equipment, bandwidth allocated when the aerial base station transmits data to the plurality of user equipment, and a ratio of resources used by a backhaul link and access links, and
wherein the determining step includes: determining the flight path, power allocation, and bandwidth allocation of the aerial base station to maximize the sum of received data rates of the plurality of user equipment while satisfying the set requirement conditions; and determining beam parameters and the ratio of resources based on the determined flight path, power allocation, and bandwidth allocation of the aerial base station.

9. The method of claim 8, wherein the step of determining the beam parameters and the ratio of resources includes:
determining the beam parameters based on the determined flight path of the aerial base station; and
determining the ratio of resources based on the determined flight path, power allocation, bandwidth allocation, and beam parameters of the aerial base station.

10. The method of claim 1, wherein:
the beam parameters include a transmit beam direction and a transmit beamwidth of the aerial base station, and
the determining step includes: determining the flight path of the aerial base station; and determining the beam direction and beamwidth based on the determined flight path.

11. The method of claim 10, wherein the step of determining the beam direction and beamwidth includes determining the beam direction and beamwidth such that a transmit beam of the aerial base station simultaneously covers all of the plurality of user equipment and a circle formed by the transmit beam is as small as possible.

12. The method of claim 1, wherein the determining step includes:
obtaining an optimal objective value of an optimization problem for a given flight path in the optimization problem for determining the flight path, beam parameters, and resource allocation of the aerial base station to maximize the sum of received data rates of the plurality of user equipment while satisfying the set requirement conditions;
determining the flight path of the aerial base station based on the obtained optimal objective value; and
determining the beam parameters and resource allocation of the aerial base station based on the determined flight path.

13. The method of claim 12, wherein the step of obtaining the optimal objective value and the step of determining the flight path are performed based on a particle swarm optimization (PSO) algorithm.

14. The method of claim 12, wherein the step of determining the beam parameters and resource allocation of the aerial base station includes:
determining the beam parameters based on the determined flight path of the aerial base station; and
determining the resource allocation based on the determined beam parameters.

15. The method of claim 14, wherein the resources subject to resource allocation include transmit power allocated when the aerial base station transmits data to the plurality of user equipment, bandwidth allocated when the aerial base station transmits data to the plurality of user equipment, and a ratio of resources used by a backhaul link and access links, and
wherein the step of determining the resource allocation includes: determining transmit power allocation and bandwidth allocation; and determining the ratio of resources based on the determined flight path, beam parameters, transmit power allocation, and bandwidth allocation.

16. The method of claim 1, wherein the electronic device is the aerial base station, and the method further comprises performing relay based on the determined flight path, beam parameters, and resource allocation.

17. The method of claim 1, wherein the electronic device is a device physically separated from the aerial base station, and the method further comprises providing information about the determined flight path, beam parameters, and resource allocation to the aerial base station.

18. An electronic device for determining a flight path, beam parameters, and resource allocation of an aerial base station in a system including a ground base station, an aerial base station, and a plurality of user equipment receiving data from the ground base station through relay by the aerial base station, the electronic device comprising:
a processor; and
a computer-readable storage medium containing instructions that, when executed by the processor, cause the electronic device to:
set requirement conditions including a minimum required data rate condition for each user equipment; and
determine the flight path, beam parameters, and resource allocation of the aerial base station to maximize a sum of received data rates of the plurality of user equipment while satisfying the set requirement conditions.

19. The electronic device of claim 18, wherein the beam parameters include at least one of a transmit beam direction and a transmit beamwidth of the aerial base station.

20. A non-transitory computer-readable storage medium storing instructions that, when executed by a processor of an electronic device, cause the electronic device to perform a method for determining a flight path, beam parameters, and resource allocation of an aerial base station in a system including a ground base station, an aerial base station, and a plurality of user equipment receiving data from the ground base station through relay by the aerial base station, the method comprising:
setting requirement conditions including a minimum required data rate condition for each user equipment; and
determining the flight path, beam parameters, and resource allocation of the aerial base station to maximize a sum of received data rates of the plurality of user equipment while satisfying the set requirement conditions.
